(19) United States
(12) Patent Application Publication
(10) Pub. No.: US 2004/0051852 A1
(43) Pub. Date: Mar. 18, 2004

(54) Projection optical system, exposure device using said projection optical system, and exposure method using said exposure device

(75) Inventor: Hideki Komatsuda, Ageo-shi (JP)

Correspondence Address: STAAS & HALSEY LLP, SUITE 700, 1201 NEW YORK AVENUE, N.W., WASHINGTON, DC, 20005, US

(73) Assignee: NIKON CORPORATION, Tokyo (JP)

(21) Appl. No.: 10/606,109

(22) Filed: Jun. 26, 2003

(30) Foreign Application Priority Data
Jun. 27, 2002 (JP) 2002-188372

(51) Int. Cl. G03B 21/28

(52) U.S. Cl. 353/99

(57) ABSTRACT

A projection optical system of an exposure device controls spherical aberrations in optical elements by providing optical elements with an aspherical surface shape corrected in accordance with a non-even function Z=g(h) having a derivative that becomes zero on a rotation axis of the aspheric surface.

### CROSS-REFERENCE TO RELATED APPLICATIONS

This application claims the benefit of Japanese Application No. 2002-188372, filed Jun. 27, 2002, in the Japanese Intellectual Property Office, the disclosure of which is incorporated herein by reference.

### BACKGROUND OF THE INVENTION

1. Field of the Invention

The present invention relates to a projection optical system of an exposure device forming a reduced image of a mask pattern on a substrate, and to an exposure device and exposure method equipped with the projection optical system.

2. Description of the Related Art

Heretofore, when manufacturing semiconductor devices or liquid crystal display devices using lithographic technology, projection exposure was performed by illuminating a mask having a pattern formed in it with illuminating light for exposure (exposure light) of the image of the pattern of the mask on a semiconductor wafer or glass plate or the like substrate coated with photoresist or the like photosensitive material via a projection optical system. In recent years, because the fineness required in the pattern has increasingly become greater, the exposure device performing the projection exposure has been required to have a higher resolving power.

In order to satisfy the increased resolving power requirement, it was necessary to shorten the wavelength of the exposure light emitted from the light source and to increase the numerical aperture (NA) of the optical system. Nevertheless, when the wavelength of the exposure light becomes shorter, optical glasses which are suitable for practical use are limited because of light absorption; for example, when the wavelength is 180 nm or less, fluorite is the only glass material which may be used in practice. Moreover, with further shortening of the wavelength to ultraviolet or X-rays, no optical glasses exist which may be used. In such a case, it becomes completely impossible to configure a reducing projection optical system by means of refracting optical systems only, or reflecting-refracting optical systems.

Thus, a projection optical system by a reflecting system only, designated a reflecting reducing projection optical system, is disclosed, for example, in Japanese Laid-Open Patent Publication Hei 9-211332.

However, in the surface shape of lenses, mirrors and such optical elements comprising a projection optical system, aspheric surface configurations are used in order to reduce the aberration of the projection optical system. In the prior art, Equation 1 is generally used in order to represent the surface form of an aspheric surface.

$$\begin{matrix}z = {ch}^{2} / \{ 1 + {[ 1 - ( 1 + k ) \cdot {c}^{2} \cdot {h}^{2} ]}^{1 / 2} \} + ( A ) {h}^{4} + ( B ) {h}^{6} + ( C ) {h}^{8} + \\ ( D ) {h}^{10} + ( E ) {h}^{12} + ( F ) {h}^{14} + ( G ) {h}^{16} + ( H ) {h}^{18} + ( J ) {h}^{20}\end{matrix} \qquad Equation 1$$

Here, z is the sag amount from the optical axis, c is the curvature at the surface vertex (=1/(curvature radius)), h is the height from the optical axis, k is a cone factor (when k=0, the first term is an expression for a spherical surface; when k=−1, the first term becomes an expression for a paraboloid), A is a fourth degree aspheric surface coefficient, B is a sixth degree aspheric surface coefficient, C is an eighth degree aspheric surface coefficient, D is a tenth degree aspheric surface coefficient, E is a twelfth degree aspheric surface coefficient, F is a fourteenth degree aspheric surface coefficient, G is a sixteenth degree aspheric surface coefficient, H is an eighteenth degree aspheric surface coefficient, and J is a twentieth degree aspheric surface coefficient.

Namely, in the prior art, the surface shape of a lens, a mirror, and such optical elements to be represented is a rotationally symmetrical surface with the optical axis as an axis; because the cross section has line symmetry with the optical axis lying between, only the even numbered terms were used in Equation 1 and in the power series portion of the second term.

Nevertheless, by means of Equation 1, the degrees of freedom of the surface shape representation of the surface periphery are high, but at the surface center portion, the degrees of freedom become low, namely, the degrees of freedom become low for the surface shape representation close to the optical axis because the change of the degree of the power series terms of the even function in Equation 1 from the optical axis is abrupt, accompanying the separation from the optical axis.

### SUMMARY OF THE INVENTION

An aspect of the present invention is to provide a projection optical system of an exposure device which comprises optical element(s) represented by an optical element unit having a surface shape represented by high degrees of freedom of shape representation in a whole surface. Moreover, it is an aspect of the present invention to provide an exposure device equipped with such a projection optical system, and an exposure method using the exposure device.

Additional aspects and/or advantages of the present invention are set forth in part in the description which follows and, in part, will be obvious from the description, or may be learned by practice of the invention.

According to an embodiment of the present invention, in a projection optical system of an exposure device which performs projection exposure on a second surface of the image of a pattern formed on a first surface, at least one optical element contained in the projection optical system has a rotationally symmetrical aspheric surface. A surface shape of the optical element is represented by a non-even function Z=g(h), a distance between the aspheric surface and a plane at a vertex of the surface perpendicular to the rotation axis of the aspheric surface is represented by Z, where the distance is measured parallel to the rotation axis, and a distance from the rotation axis is h. When the distance from the rotation axis is h, the function g(h) is a function which is not an even function, and dg(0)/dh=0 on the rotation axis.

According to an embodiment, the projection optical system may include six optical elements that are mirrors.

According to an embodiment of the present invention, because the function representing the rotationally symmetrical aspheric surface shape is a function which is not an even function whose derivative becomes zero on the rotation axis, the surface shape of the aspheric surface may be smoothed. Moreover, the degrees of freedom for the function representing the aspheric surface shape may be increased, allowing more precise control of the surface shape.

Further, according to an embodiment of the present invention, the projection optical system of an exposure device may be a reflection type projection optical system comprising a reflection system.

According to an embodiment of the present invention, the aspheric surface shape of the optical element comprising the reflection type projection optical system may be precisely controlled.

In addition, according to an embodiment of the present invention, the function that is not an even function may be a function having power series terms.

According to an embodiment of the present invention, by using odd number degree terms added to even number degree terms as the power series terms, the low order parameters of the function representing the aspheric surface shape may be increased, and the surface shape of portions of the aspheric surface shape close to the optical axis may be precisely controlled.

Also, according to an embodiment of the present invention, the degree of each term of the power series may be a number greater than 1.

According to an embodiment of the present invention, by using a number other than a natural number greater than 1 as the degree of the power series terms, the degrees of freedom of the aspheric surface shape may be increased.

In addition, according to an embodiment of the present invention, a mask is illuminated with exposure light, wherein the mask is disposed in a first surface, and an image of a pattern formed in the mask is projected via a projection optical system onto a photosensitive substrate disposed in a second surface. An exposure device may include a plurality of reflecting mirrors may be arranged to reflect source light and illuminate the mask, a first variable aperture control unit, a first variable aperture diaphragm, coupled to and controlled by the first variable aperture control unit, and arranged in a path of the source light to control a shape of the source light, and a projection optical system. The projection optical system may include an optical element having a rotationally symmetrical aspheric surface, wherein a surface shape of the symmetrical aspheric surface of the optical element is represented by a non-even function Z=g(h), a distance between the aspheric surface and a plane at a vertex of the surface perpendicular to the rotation axis of the aspheric surface is represented by Z where the distance is measured parallel to the rotation axis, and a distance from the rotation axis is h. Where desired, the projection optical system may include six optical elements that are mirrors. The non-even function Z=g(h) may have a derivative that is zero on the rotation axis.

According to an embodiment of the invention, the exposure device may further include a second variable aperture control unit and a second variable aperture diaphragm, coupled to and controlled by the second variable aperture control unit, and arranged in the projection optical system to control a shape of reflected light.

According to an embodiment of the present invention, because the exposure process is performed using the projection optical system that has an excellent imaging capacity with efficient correction for aberration, even fine patterns may be formed with excellent accuracy.

Moreover, according to an embodiment of the present invention, in an exposure method, a mask disposed in a first surface is illuminated with exposure light, and an image of a pattern formed in the mask based on the illuminating light is formed on a photosensitive substrate disposed in a second surface. The exposure method may include using an optical element having a rotationally symmetrical aspheric surface, the rotationally symmetrical aspheric surface being located in an interval of a plane perpendicular to a rotation axis of the aspheric surface and the aspheric surface, wherein a surface shape of the symmetrical aspheric surface of the optical element is represented by a non-even function Z=g(h), a distance between the aspheric surface and a plane perpendicular to the rotation axis of the aspheric surface is represented by Z where the distance is measured parallel to the rotation axis, and a distance from the rotation axis is h. The non-even function Z=g(h) may have a derivative that is zero on the rotation axis.

According to an embodiment of the present invention, a projection optical system may include an optical element having an aspheric surface with a configuration represented by a non-even function Z=g(h), a distance between the aspheric surface and a plane perpendicular to the rotation axis of the aspheric surface being represented by Z where the distance is measured parallel to the rotation axis, and a distance from the rotation axis is h, wherein the optical element performs a projection exposure on a second surface of an image of a pattern formed on a first surface. Where desired, the projection optical system may include six optical elements that are mirrors. The non-even function Z=g(h) may have a derivative that is zero on the rotation axis.

According to an embodiment of the present invention, the projection optical system may have a non-even function of the configuration of the aspheric surface of the optical element that is represented by the following equation:

$$Z = \frac{{h}^{2} / r}{1 + sqrt \{ 1 - ( 1 + k ) {h}^{2} / {r}^{2} \}} + {\sum }_{n = 2}^{28} {Cnh}^{n} ,$$

wherein the distance measured parallel to the rotation axis, Z, is an optical axis direction sag amount from a plane, r is a radius of curvature at a surface vertex, h is a distance from the rotation axis, k is a predetermined cone coefficient wherein when k=0, a first term is an expression for a spherical surface and when k=−1, the first term is an expression of a paraboloid, and C2-C28 are predetermined 2nd through 28th aspheric coefficients. Where selected, Z may be a function having power series terms wherein odd number degree terms are added to even number degree terms and a degree of each term of the power series terms is greater than 1. Where selected, the system may be a reflection system.

According to an embodiment of the present invention, the projection optical system may be a non-telecentric optical system.

According to an embodiment of the present invention, the projection optical system may include a variable aperture control unit and a variable aperture diaphragm controlled by the variable aperture control unit, arranged to control a shape of reflected light.

According to an embodiment of the present invention, a projection optical system, may include an optical element having an aspheric surface with an aspheric surface configuration represented by a function having maximized degrees of freedom for the aspheric surface configuration of a whole surface of the at least one optical element, wherein the optical element performs a projection exposure on a second surface of an image of a pattern formed on a first surface. Where selected, the function of the aspheric surface configuration of the optical element may be represented by the following equation:

$$Z = \frac{{h}^{2} / r}{1 + sqrt \{ 1 - ( 1 + k ) {h}^{2} / {r}^{2} \}} + {\sum }_{n = 2}^{28} {Cnh}^{n} ,$$

wherein a distance between the aspheric surface and a plane perpendicular to the rotation axis of the aspheric surface is represented by Z where the distance is measured parallel to the rotation axis, r is a radius of curvature at a surface vertex, h is a distance from the rotation axis, k is a predetermined cone coefficient wherein when k=0, a first term is an expression for a spherical surface and when k=−1, the first term is an expression of a paraboloid, and C2-C28 are predetermined 2nd through 28th aspheric coefficients. The system may be a reflection system.

According to an embodiment of the present invention, the exposure method may include forming the image of the pattern by stepwise scanning and illuminating a mask in a predetermined direction to obtain a plurality of shot regions that provide a whole pattern of the mask.

According to an embodiment of the present invention, a method to manufacture microdevices may utilize a projection optical system having at least one optical element having a rotationally symmetric aspheric surface and liquid crystal display cells and may include operations of illuminating a mask with exposure light; forming, on a photosensitive substrate, an image of a pattern formed in the mask based on the exposure light having illuminated the mask using a projection optical system comprising an optical element having a rotationally symmetric aspheric surface represented by a non-even function Z=g(h) having a derivative that is zero on a rotation axis, wherein a distance measured parallel to a rotation axis is represented by Z and a distance from the rotation axis is h, and wherein the optical element performs a projection exposure on a second surface of an image of a pattern formed on a first surface; forming color filters in accordance with the image; and assembling liquid crystal display cells using the photosensitive substrate and the color filters.

According to an embodiment of the present invention, a projection optical system, may include optical means for reflecting light to form an image of an object in a wafer, the optical means having an aspheric surface with a configuration represented by a non-even function Z=g(h), a distance between the aspheric surface and a plane perpendicular to the rotation axis of the aspheric surface being represented by Z where the distance is measured parallel to the rotation axis, and a distance from the rotation axis is h.

According to an embodiment of the present invention, because the exposure process is performed using the projection optical system that has an excellent imaging capacity that corrects efficiently for aberration, even fine patterns may be formed with excellent accuracy.

### BRIEF DESCRIPTION OF THE DRAWINGS

The above and/or other aspects and advantages of the invention will become apparent and more readily appreciated from the following description of the preferred embodiments, taken in conjunction with the accompanying drawings of which:

FIG. 1 is an optical path diagram of a horizontal cross section of a projection optical system of an exposure device according to an embodiment of the present invention.

FIG. 2 is a configuration diagram of an exposure device equipped with a projection optical system according to an embodiment of the present invention.

FIG. 3 is a flow chart illustrating operations of a method of manufacture of microdevices in accordance with an embodiment of the present invention.

FIG. 4 is a flow chart illustrating operations of a method of manufacture of microdevices in accordance with another embodiment of the present invention.

FIG. 5 is a graphical representation of surface deformation values for an exemplary embodiment with respect to values for h.

### DETAILED DESCRIPTION OF THE PREFERRED EMBODIMENTS

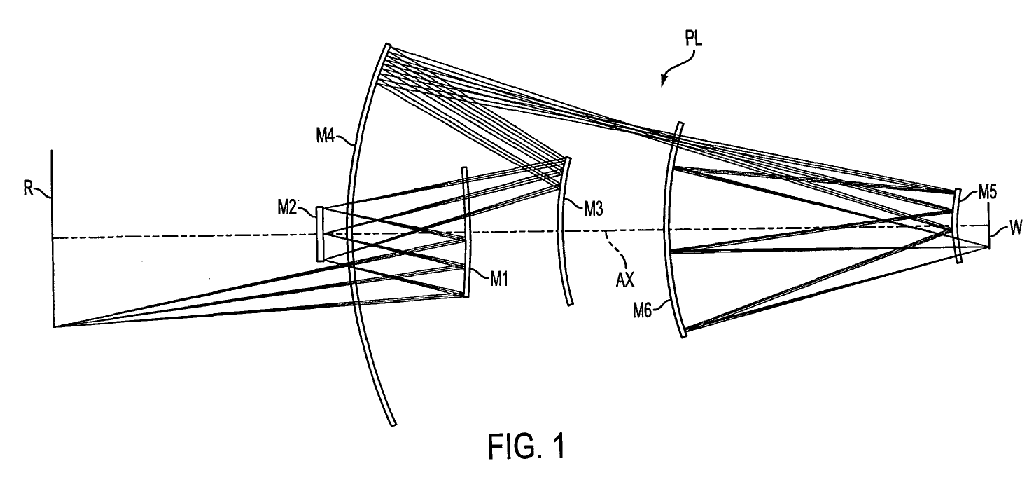

Embodiments of the present invention are described hereinafter, relating to a projection optical system of an exposure device, an exposure device, and a method of exposure, with reference to the accompanying drawings. FIG. 1 is an optical path diagram of a horizontal cross section of a projection optical system of an exposure device according to an embodiment of the present invention; in FIG. 1, the width of light rays shows only a horizontal cross section.

In FIG. 1, the projection optical system PL is a reflecting reducing projection optical system which forms a reduced image on a wafer (second surface) of an object on a reticle R (first surface). This projection optical system PL is equipped with a plurality of reflecting mirrors (M1-M6).

Here, the first reflecting mirror M1 has a concave surface arranged in the optical path between the reticle R and the wafer W. The second reflecting mirror M2 has a concave surface arranged in the optical path between the first reflecting mirror M and the water W. The third reflecting mirror M3 has a convex reflecting surface arranged in the optical path between the second reflecting mirror M2 and the wafer W. The fourth reflecting mirror M4 has a concave reflecting surface arranged in the optical path between the third reflecting mirror M3 and the wafer W. The fifth reflecting mirror M5 has a convex reflecting surface arranged in the optical path between the fourth reflecting mirror M4 and the wafer W. The sixth reflecting mirror M6 has a concave reflecting surface arranged in the optical path between the reflecting mirror M5 and the wafer W.

Moreover, the second reflecting mirror M2 has its reflecting surface facing toward the wafer W. Between the vertex of the second reflecting mirror M2 and the wafer W, the vertex of the fourth reflecting mirror M4 is fixed in position so that the reflecting surface faces toward the wafer W. Moreover, between the vertex of the fourth reflecting mirror M4 and the wafer W, the vertex of the first reflecting mirror M1 is fixed in position so that the reflecting surface faces the reticle R. Moreover, between the vertex of the first reflecting mirror M1 and the wafer W, the vertex of the third reflecting mirror M3 is fixed in position so that the reflecting surface faces toward the reticle R. Moreover, between the vertex of the third reflecting mirror M3 and the wafer W, the vertex of the sixth reflecting mirror M6 is fixed in position so that the reflecting surface faces toward the wafer W. Moreover, between the vertex of the sixth reflecting mirror M6 and the wafer W, the vertex of the fifth reflecting mirror M5 is fixed in position so that the reflecting surface faces toward the reticle R. Furthermore, the reflecting surfaces of the respective reflecting mirrors (M1-M6) comprise rotationally symmetrical aspheric surfaces. Here the reflecting surfaces of any of the reflecting mirrors among the respective reflecting mirrors (M1-M6) may comprise spherical surfaces.

The respective reflecting mirrors (M1-M6), from the reticle R toward the wafer W, are arranged in the sequence comprising the second reflecting mirror M2, the fourth reflecting mirror M4, the first reflecting mirror M1, the third reflecting mirror M3, the sixth reflecting mirror M6, and the fifth reflecting mirror M5. In this embodiment, the respective reflecting mirrors (M1-M6) are arranged on the same axis with respect to the optical axis. Furthermore, the vertex of a reflecting mirror is the point of intersection of the optical axis AX of the projection optical system PL with the reflecting mirror, and when the respective reflecting mirror does not physically exist on the optical axis, it signifies the intersection point with the virtual extended surface of the reflecting surface of the reflecting mirror.

In the projection optical system PL, an intermediate image is formed on the light path between the fourth reflecting mirror M4 and the fifth reflecting mirror M5. Namely, light from the reticle R, after having been reflected by the sequence of the second reflecting mirror M2, the third reflecting mirror M3, and the fourth reflecting mirror M4, forms an intermediate image on the light path between the fourth reflecting mirror M4 and the fifth reflecting mirror M5, and light from the intermediate image passes to the wafer W, reflected by the sequence of the fifth reflecting mirror M5 and sixth reflecting mirror M6.

The surface shape of the respective mirrors (M1-M6) comprising this projection optical system PL is represented by Equation 2.

$$Z = \frac{{h}^{2} / r}{1 + sqrt \{ 1 - ( 1 + k ) {h}^{2} / {r}^{2} \}} + {\sum }_{n = 2}^{28} {Cnh}^{n} \qquad Equation 2$$

Here, Z represents the optical axis direction sag amount from the plane; r is the radius of curvature at the surface vertex; h is the height from the optical axis (distance from the rotation axis); k is the cone coefficient (when k=0, the first term becomes the expression for a spherical surface; when k=−1, the first term becomes the expression of a paraboloid); C2-C28 are the 2nd through 28th aspheric coefficients.

Equation 2 is a function which is not an even function whose derivative becomes zero on the axis of rotation. Moreover, Equation 2 is a function which has power series terms. Moreover, only the odd integers may be used as the degree of the power series terms; furthermore, as the degree of the power series terms, any number greater than 1 (for example, 1.1, 1.3, etc.) may be used.

The surface shape of the aspheric surface may be smoothed by using the projection optical system of the exposure device that utilizes a function representing a rotationally symmetrical aspheric surface, wherein the function is a non-even function whose derivative becomes zero on the said rotation axis. Moreover, the representational degrees of freedom of the aspheric surface may be increased, and control of the surface shape may be performed precisely.

Further, by using odd function terms in addition to even function terms as power series terms, control of the surface shape of locations close to the optical axis of the aspheric surface shape may be performed precisely. Furthermore, because numbers other than natural numbers greater than 1 are used as power series terms, the degrees of freedom of the terms of the function that represents the aspheric surface shape may be increased.

Moreover, in the example embodiment illustrated, because the number, 6, of reflecting mirrors used in the projection optical system PL is small, in an embodiment wherein the projection optical system PL is applied to an exposure device, the risk of a reduction of the amount of exposure light is reduced, and in addition, due to the surface shape difference of the reflecting surfaces, the risk of incurring a deterioration of imaging capacity is also reduced. For example, as exposure light, light of soft X-rays of wavelength 5-15 nm (EUV light) may be utilized, or in the case of using X-rays of wavelength smaller than such a wavelength range, even though the reflectivity of the reflecting film is low in the wavelength range of 5-15 nm, the amount of light may be maintained to the extent that there are no problems in practical use because the number of reflecting surfaces is only six. However, embodiments of the invention are not limited to using six reflecting mirrors.

Moreover, because the concave portion of the fifth reflecting mirror M5 is positioned opposite to wafer W, the distance between the fifth reflecting mirror M5 and the wafer W (working distance) may be increased. Thus, loading the photosensitive substrate on the wafer W, etc., may be facilitiated.

Further, because the first reflecting mirror M1, the third reflecting mirror M3, and the fifth reflecting mirror M5 are respectively arranged with the respective reflecting surfaces facing toward the reticle R, and the second reflecting mirror M2, the fourth reflecting mirror M4, and the sixth reflecting mirror M6 are arranged with the respective reflecting surfaces facing toward the wafer W, light from the reticle R is passed toward the wafer W with reiterated alternate reflections between the respective reflecting mirrors (M1-M6). By such an arrangement, plane mirrors are not used to fold back the light path, and in addition, the distance between the reticle and the wafer may be decreased. Accordingly, the projection optical system PL as a whole may be implemented compactly.

Furthermore, by also arranging each reflecting mirror (M1-M6) on the same optical axis AX, the projection optical system PL as a whole may be implemented compactly, and embodiments may implement body tube insertion and/or adjustment of the respective reflecting mirrors (M1-M6).

Furthermore, according to an embodiment, an aperture diaphragm may also be disposed in the projection optical system PL. In the embodiment, the position of the aperture diaphragm in the optical axis direction may be a positional arrangement chosen so that the wafer W becomes telecentric, facilitating obtaining effective imaging properties. By varying the aperture diameter of the aperture portion of the aperture diaphragm, aberration correction may be obtained, and in addition, aberration correction may also be performed by optionally disposing the aspheric shape of the reflecting surfaces of the respective reflecting mirrors (M1-M6). Accordingly, in an embodiment disposing an aperture diaphragm, aberration correction other than adjustment of the shape of the reflecting surfaces of the respective reflecting mirrors may be performed by adjusting the position of the optical axis direction of the aperture diaphragm, and aberration correction may be performed with high degrees of freedom.

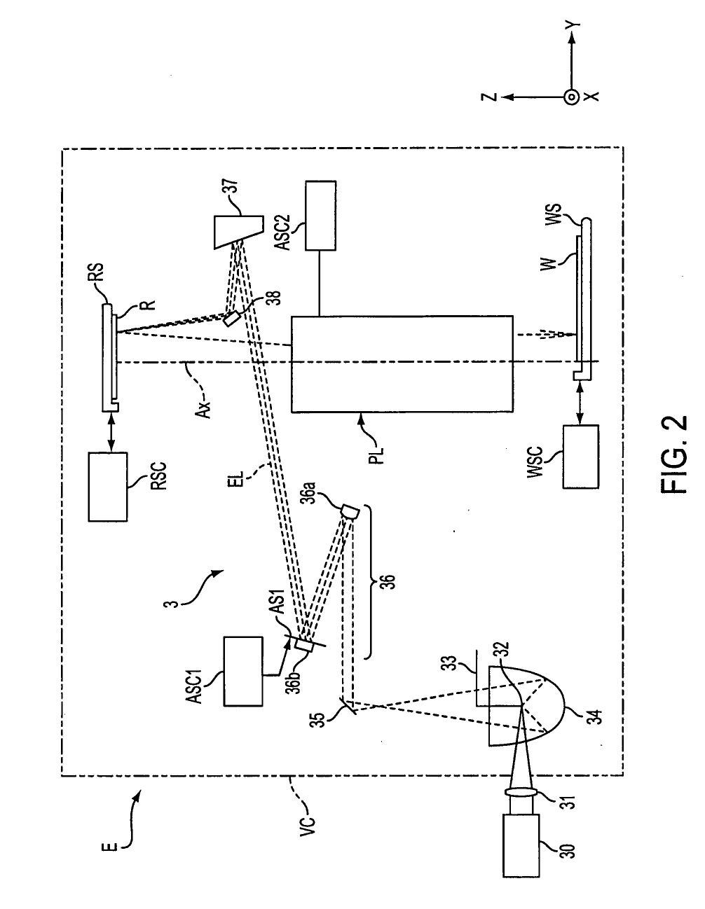

Next, according to an embodiment of the present invention, an exposure device E equipped with the projection optical system PL is described below, with FIG. 2 being a configuration diagram thereof. The exposure device E, illuminating a reticle (mask) R with illumination light used for exposure (exposure light) EL, while projecting an image of a portion of a pattern formed in the reticle R via a projection optical system PL onto a photosensitive substrate (wafer) W, by relative scanning of the reticle R and photosensitive substrate W in the direction of one dimension (Y direction) with respect to the projection optical system PL, performs the transfer, by a step and scan method in plural respective shot regions, of the whole of the pattern of the reticle R onto the photosensitive substrate W.

In an embodiment, soft X-rays of wavelength 5-15 nm (EUV light) are used as the exposure light EL. Furthermore, in FIG. 2, taking the optical axis direction of the projection optical system PL as the Z direction, and the direction at right angles to the Z direction which is the scanning direction of the reticle R and photosensitive substrate W, as the Y direction, the direction at right angles to these YZ directions is taken as the X direction.

In FIG. 2, the exposure device E is equipped with an illumination optical system 3 which illuminates the reticle R supported on a reticle stage RS with light rays from a light source 30. The projection optical system PL projects onto the photosensitive substrate W an image of the pattern on the reticle R illuminated by the exposure light EL, and a substrate stage WS which supports the substrate W. In the embodiment shown in FIG. 2, because the transmissivity of air is low for the EUV light, which is the exposure light, the light path over which the EUV light passes is enveloped by a vacuum chamber VC shielding it from the air.

The illumination optical system 3 in FIG. 2 is explained below. The light source 30 provides laser light of the infrared region to the visible region, for example, a YAG laser excited by a semiconductor laser, or an excimer laser, may be used. The laser light, condensed by a first condensing optical system 31, is condensed to a position 32. Gaseous material is transferred to the position 32 by a nozzle 33. The transferred material in position 32 receives a high illumination with laser light. In the embodiment, the transferred material reaches a high temperature due to the energy of the laser light, is excited to form a plasma, and emits EUV light during a transition to a low potential state.

An elliptical mirror 34 comprising a second condensing optical system is arranged in the periphery of position 32. The elliptical mirror 34 is fixed in a position such that a first focus coincides with the position 32. The internal surface of the elliptical mirror 34 has a multilayer film disposed to reflect EUV light. The reflected EUV light, after being once condensed at the second focus of the elliptical mirror 34, proceeds to a parabolic surface mirror 35 as a collimating mirror comprising a third condensing optical system. The parabolic surface mirror 35 is fixed in a position so that a focus coincides approximately with the position of the second focal position of the elliptical mirror 34. The internal surface of the parabolic surface mirror 35 has a multilayer film disposed to reflect EUV light.

The EUV light leaving the parabolic mirror 35 proceeds in an approximately collimated state to a reflecting type fly's eye optical system 36 as an optical integrator. The reflecting type fly's eye optical system 36 comprises a first reflecting element group 36a with an accumulated plurality of reflecting surfaces, and a second reflecting element group 36b having a plurality of reflecting surfaces corresponding to the plurality of reflecting surfaces of the first reflecting element group 36a. Multilayer films to reflect EUV light are disposed on the plurality of reflecting surfaces of the first and second reflecting element groups 36a, 36b.

Collimated EUV light from the parabolic mirror 35 is wavefront partitioned by the first reflecting element group 36a, and plural light source images are formed as the EUV light from various reflecting surfaces is condensed. The plurality of reflecting surfaces of the second reflecting element group 36b are fixed in position in the respective neighborhoods of the plural light source images. The plural reflecting surfaces of the second reflecting element group 36b substantially perform the function of field mirrors. Thus, the reflecting type fly's eye optical system 36 forms a large number of light source images as a secondary light source, based on the approximately parallel light rays from the parabolic mirror 35. Moreover, such a reflecting type fly's eye optical system 36 is disclosed in Japanese Laid-Open Patent Publication Hei 11-312638.

In an embodiment, to control the shape of the secondary light source, in the neighborhood of the second reflecting element group 36b, a σ diaphragm AS1 is disposed as an aperture diaphragm. This σ diaphragm AS1 comprises, for example, plural aperture portions, mutually different in shape, disposed in a turret form. Then, control is performed by a σ diaphragm control unit ASC1, of which an aperture portion is arranged in the light path.

The EUV light from the secondary light source formed by the reflecting type fly's eye optical system 36, proceeds toward a condenser mirror 37 which has been fixed in a position so that the neighborhood of the secondary light source becomes the focal position, and after being reflected and condensed by the condenser 37, reaches the reticle R via a light path deflecting mirror 38. To reflect EUV light, multilayer films are disposed on the surfaces of the condenser 37 and light path deflecting mirror 38. Then, the condenser 37, condensing the EUV light emitted from the secondary light source, uniformly illuminates the reticle R.

Moreover, in an embodiment, in order to spatially perform the light path separation of the illuminating light going to the reticle R and the EUV light reflected at the reticle R and going to the projection optical system PL, the illuminating optical system 3 is a non-telecentric system. Also, the projection optical system PL is a non-telecentric optical system on the reticle side.

A reflecting film is disposed on the reticle R, consisting of multilayer films which reflect EUV light. The reflecting films are patterned corresponding to the shape of the pattern to be transferred to the photosensitive substrate W. The EUV light reflected by the reticle R and containing the pattern information of the reticle R, is incident on the projection optical system PL.

The projection optical system PL, as described in FIG. 1, comprises first through sixth reflecting mirrors (M1-M6). Furthermore, in the case in which a variable aperture diaphragm is arranged in the projection optical system PL, the aperture diameter of the aperture portion of the variable aperture diaphragm is controlled by a variable aperture control unit ASC2.

The EUV light reflected by the reticle R passes through the projection optical system PL, in a circular arcuate exposure region on the photosensitive substrate W, and forms a reduced image of the pattern of the reticle R on a prescribed reduction magnification β (for example, |β|=¼, ⅕,⅙).

The reticle R is supported by reticle stage RS which is movable along at least the Y direction. The photosensitive substrate W is supported by substrate stage WS, which is movable along the XYZ directions. The movement of the reticle stage RS and the substrate stage WS is respectively controlled by a reticle stage control unit RSC and a substrate stage control unit WSC. During the exposure operation, while illuminating the reticle R with EUV light by the illumination optical system 3, the reticle R and photosensitive substrate W move with respect to the projection optical system PL at a fixed speed ratio set by the reduction magnification of the projection optical system PL. Thus, the pattern of the reticle R is scan exposed in predetermined shot regions on the photosensitive substrate W.

Furthermore, in the present embodiment, in order for the σ diaphragm AS1 and the variable aperture diaphragm AS to be a sufficient barrier to EUV light, the diaphragms are typically comprised of the metals Au, Ta, W or the like. Moreover, multilayer films are formed as reflecting films on the surface of the reflecting surfaces of the said respective reflecting mirrors (M1-M6) to reflect EUV light. The multilayer film is formed by laminating multiple materials from among molybdenum, ruthenium, rhodium, silicon, and silicon oxide.

Furthermore, in the projection optical system PL, since the reflecting surfaces of the respective reflecting mirrors (M1-M6) are formed as rotationally symmetrical, high order aspheric surface shapes, effective imaging capacity is attained, correcting high order aberration generated by the respective reflecting mirrors (M1-M6). Here, to correct rotationally asymmetrical aberration components originating in surface shape errors of the respective reflecting mirrors, or in assembly errors and the like during the manufacture of the projection optical system, the rotationally symmetrical aspheric surfaces may be made as rotationally asymmetrical aspheric surfaces.

As the exposure device of an embodiment of the present invention, a step and repeat type of exposure device may be used to expose the pattern of the mask with the mask and substrate in a stationary state, causing the substrate to move in a series of steps.

The utility of the exposure device is not limited to exposure for semiconductor manufacture, but may be widely applied, for example, as an exposure device used for liquid crystals, exposing a liquid crystal display element pattern on a square glass plate, or for exposure in order to manufacture a thin layer magnetic head.

When using a linear motor in the substrate stage or reticle stage, either an air flotation type of linear motor using air bearings or a magnetic flotation type of linear motor using Lorentz force or reactance force may be utilized. Moreover, the stage may be a type of stage that moves along guides, or may be a guideless t type without guides.

When using a linear motor as the drive of a stage, either a magnetic unit (permanent magnet) or an electromagnetic unit may be connected to the stage, or the magnetic unit or a electromagnetic unit may be disposed on the moving surface side (base) of the stage.

As disclosed in Japanese Laid-Open Patent Publication Hei 8-166475 and Japanese Laid-Open Patent Publication Hei 8-330224, due to the movement of the reticle stage, a reaction force is generated and may be mechanically dissipated to a floor (ground), using frame members. In accordance with embodiments of the present invention, the exposure device may be equipped with such a structure.

As described above, the exposure device of an embodiment may be constructed by the assembly of various kinds of subsystems which include various constructional requirements, to maintain a predetermined mechanical precision, an electrical precision, and an optical precision. To ensure the various kinds of precision, before and after assembly, adjustment to attain optical precision with respect to each kind of optical system, adjustment to attain mechanical precision with respect to each kind of mechanical system, and adjustment to attain electrical precision with respect to each kind of electrical system are preformed. The assembly process to the exposure device from each kind of subsystem mutually includes the mechanical connections, the wiring connections of electrical circuits, and the piping connections of pneumatic circuits. Before the process of assembly from the various kinds of subsystems to the exposure device, the individual subsystems are assembled. When the process of assembly of the various subsystems to the exposure device ends, coordinated adjustment is performed, and each kind of precision of the whole exposure device is ensured. Furthermore, typically a clean room in which temperature and cleanliness are controlled is utilized for the manufacture of the exposure device.

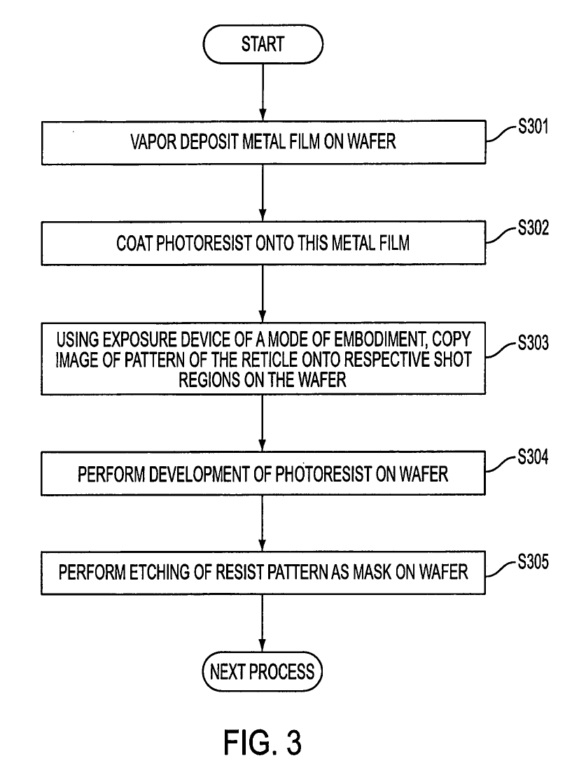

In the exposure device, according to the above embodiment, by illuminating the mask using the illumination optical device (illumination process), exposing the photosensitive substrate with the pattern used for transfer formed on the mask using the projection optical system (exposure process), microdevices (semiconductor elements, camera elements, liquid crystal elements, thin film magnetic heads and the like) may be manufactured. A method of manufacturing semiconductor devices by forming predetermined circuit patterns on a photosensitive substrate of a wafer or the like, obtaining semiconductor devices as microdevices, and using the exposure device of the embodiment as shown in FIG. 2, is described hereinbelow with reference to the flow chart of FIG. 3.

First, in operation S301 of FIG. 3, vapor film is deposited on wafers of a first batch. Next, in operation S302, photoresist is coated onto the metal film on the wafers of the batch. After this, in operation S303, using the exposure device the embodiment shown in FIG. 2, an image of the pattern on the mask is transferred in successive exposures to each shot region of the wafers of the batch, namely, by illuminating the mask by the illuminating optical system (illumination process) and transferring the pattern of the mask onto the wafer (exposure process).

Then, in operation S304, after the photoresist has been developed on the wafers of the first batch, in operation S305, the circuit pattern corresponding to the pattern on the mask is formed on each shot region of the respective wafers by performing etching of the resist pattern on the wafers of the first batch as a mask. Then, a device of semiconductor elements is manufactured by forming a further upper layer of a circuit pattern. By using such a semiconductor device manufacturing method, semiconductor devices having very fine circuit patterns are obtained.

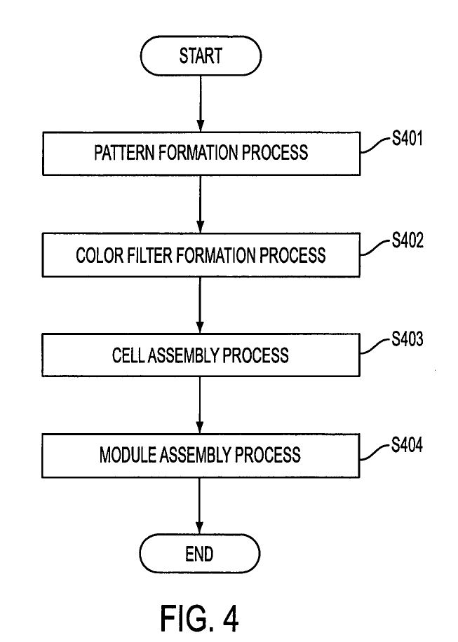

A method of manufacturing liquid crystal elements as microdevices is described below with reference to the flow chart of FIG. 4. In FIG. 4, in pattern formation process S401, a photolithographic process is implemented for transfer exposure of the pattern of a mask to a photosensitive substrate (glass substrate, etc., coated with photoresist) using an exposure device of the above-described embodiment. Using the photolithographic process, a predetermined pattern is formed, containing a plurality of electrodes and the like on the photosensitive substrate. Then, the exposed substrate, by passing through a development process, an etching process, a reticle stripping process and such other processes, proceeds to the color filter formation process S402.

Next, in the color filter formation process S402, color filters are formed with plural groups of three dots corresponding to R (red), G (green), B (blue) arranged in matrix form, or plural groups of three R, G, B stripes arranged in plural horizontal scan line directions. Then, after the color filter formation process S402, the cell assembly process S403 is performed. In the cell assembly process S403, a substrate having the predetermined pattern obtained in the pattern formation process S401, using the color filters obtained in the color filter formation process S402, is assembled into a liquid crystal pattern (liquid crystal cells). In the cell assembly process S403, for example, a liquid crystal panel (liquid crystal cell) is manufactured, implanting liquid crystals between the substrate having the predetermined pattern obtained in the pattern formation process S401 and the color filters obtained in the color filter formation process S402.

Then, various components are installed and completed as liquid crystal display elements in a module assembly process S404, the electrical circuit performing the display operation of the assembled liquid crystal panel (liquid crystal cell), back lighting and the like. By using the manufacturing method of liquid crystal display elements, liquid crystal display elements having very fine circuit patterns are obtained.

### EXAMPLES

A number of examples of projection optical systems according to embodiments of the present invention are described hereinafter. In the examples, the respective reflecting mirrors (M1-M6) have rotationally symmetrical aspheric surface shapes with respect to the optical axis AX, and the aspheric surface shape is represented by Equation 2. Furthermore, in the projection optical system PL of the examples, the wavelength of the EUV light is 13.4 nm, the reduction magnification |β| is ¼ times, the object side numerical aperture NA is 0.26, the object height is 28.5-30.5, and it is telecentric on the object side.

The following Table 1 shows the values of items of the projection optical system PL of the examples. In Table 1, the surface number is shown on the left-hand side. Further, INFINITY is shown as a radius of curvature to show that the surface is a plane surface. Distance shows the interval between the surfaces of respective reflecting surfaces. Furthermore, as the units showing the radius of curvature and distance, for example, mm may be used.

TABLE 1

| | | Distance to | |
|---|---|---|---|
| Surface No. | Radius of Curvature | Next Surface | Surface Properties |
| Object surface | INFINITY | 425.935994 | |
| 1 | −456.17243 | −379.865884 | reflecting surface |
| 2 | −283.60886 | 812.301158 | reflecting surface |
| 3 | −572.19606 | −284.980316 | reflecting surface |
| 4 | −473.86081 | 325.006092 | reflecting surface |
| 5 | −1850.76542 | −197.830465 | reflecting surface |
| 6 | 845.19850 | 565.458441 | reflecting surface |
| Image surface | INFINITY | 0.000000 | |

Next, Table 2 shows the aspheric surface coefficients of the respective surfaces.

TABLE 2

| | | |
|---|---|---|
| Surface 1 | | |
| K: −2.3783E−04 | C2: 1.7011E−07 | C3: −2.6657E−12 |
| C4: −7.2502E−11 | C5: −5.1912E−15 | C6: −3.8826E−16 |
| C7: −5.2208E−20 | C8: −9.9392E−21 | C9: 6.3168E−24 |
| C10: 8.7305E−25 | C11: 1.9777E−28 | C12: −8.9063E−29 |
| C13: −2.0782E−32 | C14: 5.8945E−33 | C15: 1.8236E−36 |
| C16: −2.5476E−37 | C17: −7.0690E−41 | C18: 6.6004E−42 |
| C19: −7.2056E−46 | C20: −6.8953E−47 | C21: 2.4590E−51 |
| C22: −6.6378E−54 | C23: 2.5269E−55 | C24: 1.2382E−57 |
| C25: −8.9493E−63 | C26: −1.0987E−64 | C27: −1.1772E−66 |
| C28: −1.7587E−73 | | |
| Surface 2 | | |
| K: 2.7468E−03 | C2: 1.5680E−06 | C3: −2.0660E−10 |
| C4: 5.5851E−10 | C5: −8.8949E−13 | C6: −1.3588E−12 |
| C7: 5.4489E−16 | C8: −2.0339E−17 | C9: −1.9250E−19 |
| C10: 1.2195E−19 | C11: 6.3610E−23 | C12: −1.4070E−22 |
| C13: −2.5492E−26 | C14: 1.0440E−25 | C15: 2.0453E−29 |
| C16: −4.8789E−29 | C17: 2.2276E−32 | C18: 1.2144E−32 |
| C19: −1.2824E−36 | C20: −1.3359E−36 | C21: −5.3704E−40 |
| C22: −3.9624E−42 | C23: 1.6924E−43 | C24: 1.5032E−45 |
| C25: 2.7214E−50 | C26: 9.6033E−52 | C27: 3.0943E−53 |
| C28: 2.1198E−60 | | |
| Surface 3: | | |
| K: 1.1161E−03 | C2: 7.8019E−08 | C3: −4.5369E−10 |
| C4: −9.5050E−12 | C5: 3.0907E−16 | C6: 1.1734E−15 |
| C7: 1.8487E−20 | C8: −2.2897E−20 | C9: −5.5240E−25 |
| C10: 1.8220E−25 | C11: −1.9324E−29 | C12: 2.9893E−31 |
| C13: 2.4131E−34 | C14: 1.4619E−35 | c15: −5.7714E−39 |
| C16: −8.0527E−40 | C17: 2.2674E−43 | C18: 9.0065E−45 |
| C19: −4.5154E−49 | C20: −3.6506E−50 | C21: 1.2331E−54 |
| C22: −1.0441E−57 | C23: 9.4048E−60 | C24: −2.0904E−64 |
| c25: 1.3253E−68 | C26: 1.3380E−70 | C27: 9.0623E−73 |
| C28: 6.0290E−81 | | |
| Surface 4 | | |
| K: 8.2662E−03 | C2: −1.9874E−06 | C3: 3.9893E−09 |
| C4: 1.8745E−09 | C5: −1.9615E−13 | C6: 1.6621E−14 |
| C7: 1.5718E−17 | C8: −2.1325E−18 | C9: −3.7647E−22 |
| C10: −1.5172E−22 | C11: −2.6679E−25 | C12: 6.6637E−26 |
| c13: 5.1691E−29 | C14: −7.5950E−30 | C15: −3.3712E−33 |
| C16: 3.4272E−34 | C17: 5.4606E−37 | C18: −5.2996E−39 |
| C19: −5.3574E−42 | C20: −1.9920E−43 | C21: 1.6615E−46 |
| C22: −1.8568E−48 | C23: 9.8777E−51 | C24: 7.6768E−53 |
| C25: 1.4812E−58 | C26: 1.5918E−60 | C27: 3.3129E−63 |
| C28: 1.7245E−68 | | |
| Surface 5 | | |
| K: −9.9604E−01 | C2: −2.4081E−06 | C3: −2.6467E−10 |
| C4: 1.0269E−09 | C5: 7.0454E−12 | C6: 4.7285E−13 |
| C7: −8.3492E−15 | C8: −2.0933E−16 | C9: 5.6629E−18 |
| C10: 3.8230E−19 | C11: −4.5621E−21 | C12: −5.1013E−22 |
| C13: 1.7343E−24 | C14: 4.9048E−25 | C15: 1.1690E−29 |
| C16: −2.7729E−28 | C17: −1.4155E−30 | C18: 1.1837E−31 |
| C19: −2.2617E−35 | C20: −1.0974E−35 | C21: −2.2226E−38 |
| C22: −1.4837E−40 | C23: −3.5692E−42 | C24: −2.8489E−43 |
| C25: −7.3992E−49 | C26: −8.8994E−50 | C27: −4.6393E−51 |
| C28: −4.1081E−58 | | |
| Surface 6: | | |
| K: 3.3526E−02 | C2: −1.6755E−06 | C3: −3.8464E−10 |
| C4: −3.3437E−09 | C5: −4.8176E−13 | C6: 7.7074E−14 |
| C7: 7.3939E−18 | C8: −1.6031E−18 | C9: −7.8250E−22 |
| C10: −3.4097E−22 | C11: 2.1888E−25 | C12: 1.2449E−25 |
| C13: 3.4107E−31 | C14: −2.4267E−29 | C15: −1.8952E−33 |
| C16: 2.8468E−33 | C17: 5.1406E−38 | C18: −1.8781E−37 |
| C19: 2.6081E−41 | C20: 5.4-0429E−42 | C21: 2.4427E−45 |
| C22: 5.6300E−48 | C23: −7.7264E−50 | C24: −1.2461E−51 |
| C25: −5.1895E−57 | C26: −7.2591E−59 | C27: −9.2420E−61 |
| C28: −5.7876E−69 | | |

### COMPARISON EXAMPLE

Next, the case of numerical values of a projection optical system relating to a comparison example will be described. In the comparison example, the respective reflecting mirrors have aspheric surface shapes which are rotationally symmetrical with respect to the optical axis AX; the aspheric surface shapes are represented by Equation 1. Furthermore, for the projection optical system PL of the comparison example, the wavelength of the EUV light is 13.4 nm, the reduction magnification |β| is ¼ times, the object side numerical aperture NA is 0.26, the object height is 28.5-30.5, and it is telecentric on the object side.

The following Table 3 shows the values of items of the projection optical system PL of the example. In Table 3, the surface number is shown on the left-hand side. Moreover, INFINITY is shown as a radius of curvature that shows that the surface is a plane surface. Distance shows the interval between surfaces of respective reflecting surfaces. Furthermore, as the units showing the radius of curvature and distance, for example, mm may be used.

TABLE 3

| | Radius of | Distance to | |
|---|---|---|---|
| Surface No. | Curvature | Next Surface | Surface Properties |
| Object surface | INFINITY | 425.927787 | |
| 1 | −456.09141 | −379.738374 | reflecting surface |
| 2 | −283.27475 | 811.523851 | reflecting surface |
| 3 | −572.17902 | −284.721038 | reflecting surface |
| 4 | −475.53173 | 324.721041 | reflecting surface |
| 5 | −1873.95212 | −1979535335 | reflecting surface |
| 6 | 842.28427 | 565.650981 | reflecting surface |
| Image surface | INFINITY | 0.000000 | |

Next, the aspheric coefficients of the respective surfaces are shown in Table 4.

TABLE 4

| | | |
|---|---|---|
| Surface 1 | | |
| K: 0.000000 | | |
| A: −.729009E−10 | B: −.455441E−15 | C: −.425300E−20 |
| D: 0.336933e-24 | E: −.430162E−28 | F: 0.327952E−32 |
| G: −.150876E−36 | H: 0.381455E−41 | J: −.406522E−46 |
| Surface 2: | | |
| K: 0.000000 | | |
| A: 0.564559E−09 | B: −.138427E−11 | C: −.129326E−16 |
| D: 0.125004E−18 | E: −.151221E−21 | F: 0.116099E−24 |
| G: −.550149E−28 | H: 0.145784E−31 | J: −.164731E−35 |
| Surface 3: | | |
| K: 0.000000 | | |
| A: −.769711E−11 | B: 0.113803E−14 | C: −.236970E−19 |
| D: 0.191240E−24 | E: 0.475697E−30 | F: 0.120227E−34 |
| G: −.860800E−39 | H: 0.107925E−43 | J: −.436807E−49 |
| Surface 4: | | |
| K: 0.000000 | | |
| A: 0.187603E−08 | B: 0.166116E−13 | C: .257848E−17 |
| D: −883861E−22 | E: 0.651218E−25 | F: −831590E−29 |
| G: 0.489836E−33 | H: −.118773E−37 | J: 0.238588E−43 |
| Surface 5: | | |
| K: 0.000000 | | |
| A: 0.97627E−09 | B: 0.695584E−13 | C: −431643E−16 |
| D: 0.169941E−18 | E: −357351E−21 | F: 0.457065E−24 |
| G: 0.169941E−18 | H: 0.147215E−30 | J: −262864E−34 |
| Surface 6: | | |
| K: 0.000000 | | |
| A: −335943E−08 | B: 0.725097E−13 | C: −.128763E−17 |
| D: −.310444E−21 | E: 0.110104E−24 | F: −.216374E−28 |
| G: 0.259711E−32 | H: −173407E−36 | J: 0.496192E−41 |

Discussion

Shown below are the wavefront aberration and image distortion for the respective image heights. For the wavefront aberration, using 13.4 nm light, ray tracing was performed from the wafer side, and the RMS value of wavefront aberration is shown in Table 5.

TABLE 5
Wavefront aberration (RMS)

| | | Example |
|---|---|---|
| Image Height | Comparison Example | (Invention Embodiment) |
| 28.5 | 0.0049 | 0.0044 |
| 29 | 0.0033 | 0.0031 |
| 29.5 | 0.0054 | 0.0046 |
| 30 | 0.0046 | 0.0039 |
| 30.5 | 0.0055 | 0.0054 |

TABLE 6
Image Distortion (Displacement from ideal image position, nm)

| | | Example |
|---|---|---|
| Image Height | Comparison Example | (Invention Embodiment) |
| 28.5 | −2.0 | 3.2 |
| 29 | 3.6 | 3.2 |
| 29.5 | 0.3 | 0.2 |
| 30 | −3.5 | −3.3 |
| 30.5 | 1.6 | 3.2 |

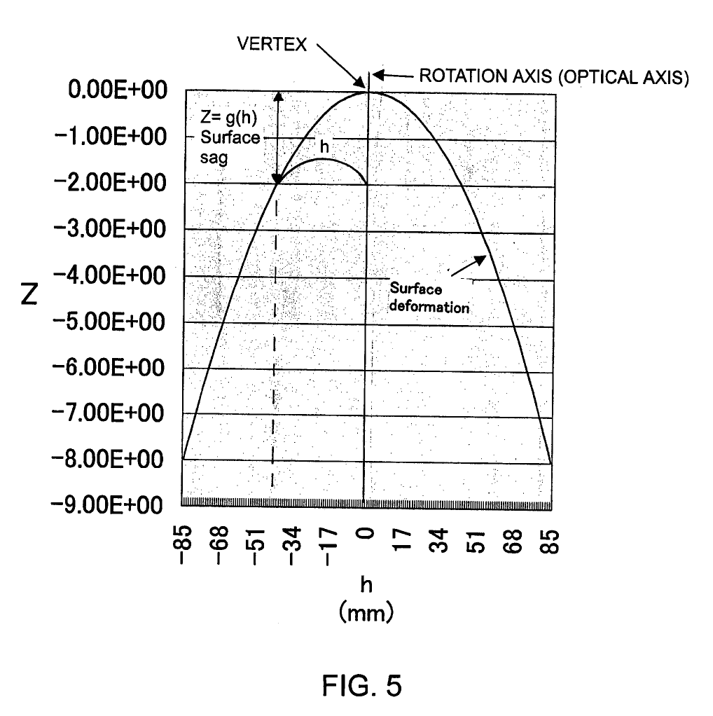

It is clear from the values that wavefront aberration and image distortion are improved according to embodiments of the present invention. Namely, as regards wavefront aberration, the values for the examples (invention embodiments) are smaller than those for the comparison examples, and as regards image distortion (see Table 6), the scatter of the values is smaller for the examples (invention embodiments) than for the comparison examples. FIG. 5 is a graphical representation of surface deformation values for the exemplary embodiment with respect to values for h.

Effects of the Invention

When the projection optical system of the exposure device of embodiments of the present invention is utilized, since the function representing the rotationally symmetrical aspheric surface shape is not an even function whose derivative becomes zero on the said axis of rotation, the surface of the aspheric surfaces may be smoothed. Moreover, the degrees of freedom for representing the aspheric surface shape can be made large, and control of surface shape can be finely performed.

Further, by using odd function terms in addition to even function terms as power series terms, the low order parameters of the function showing the aspheric surface shape may be increased, and control close to the rotation axis of the aspheric surface shape may be precisely performed. In addition, to represent the aspheric surface shape, since numbers other than natural numbers greater than 1 are used as the degree of the power series terms, the degrees of freedom representing the aspheric surface shape may be further increased.

Also, by utilizing the exposure device of embodiments of the present invention, the exposure process performed that uses the projection optical system has excellent imaging capacity with aberration effectively corrected, so that even fine patterns may be formed with considerable precision.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A projection optical system of an exposure device, comprising:
an optical element having a rotationally symmetrical aspheric surface,
wherein a surface shape of the optical element is represented by a non-even function Z=g(h), a distance between the aspheric surface and a plane at a vertex of the surface perpendicular to the rotation axis of the aspheric surface being represented by Z where the distance is measured parallel to the rotation axis, and a distance from the rotation axis is h, and
wherein the optical element performs a projection exposure on a second surface of an image of a pattern formed on a first surface.

2. The projection optical system of the exposure device of claim 1, wherein the projection optical system comprises six optical elements that are mirrors.

3. The projection optical system of the exposure device of claim 1, wherein non-even function Z=g(h) has a derivative that is zero on the rotation axis.

4. The projection optical system of the exposure device according to claim 1, wherein the projection optical system of the exposure device is a reflection type projection optical system comprising a reflection system.

5. The projection optical system of the exposure device according to claim 1, wherein the function Z=g(h) is a function having power series terms.

6. The projection optical system of the exposure device according to claim 1, wherein the function Z=g(h) is a function having odd function terms added to even function terms.

7. The projection optical system of the exposure device according to claim 5, wherein a degree of each term of the power series is a number greater than 1.

8. An exposure device to illuminate a mask with exposure light, the mask being disposed in a first surface, to project an image of a pattern formed in the mask via a projection optical system onto a photosensitive substrate disposed in a second surface, comprising:
a plurality of reflecting mirrors, arranged to reflect source light and illuminate the mask;
a first variable aperture control unit;
a first variable aperture diaphragm, coupled to and controlled by the first variable aperture control unit, arranged in a path of the source light to control a shape of the source light; and
a projection optical system comprising
an optical element having a rotationally symmetrical aspheric surface,
wherein a surface shape of the symmetrical aspheric surface of the optical element is represented by a non-even function Z=g(h), a distance between the aspheric surface and a plane at a vertex of the surface perpendicular to the rotation axis of the aspheric surface being represented by Z wherein the distance is measured parallel to the rotation axis, and a distance from the rotation axis is h, and
wherein the optical element performs a projection exposure on the second surface of an image of a pattern formed on the first surface.

9. The exposure device of claim 8, wherein the projection optical system comprises six optical elements that are mirrors.

10. The exposure device of claim 8, wherein the non-even function Z=g(h) has a derivative that is zero on the rotation axis.

11. The exposure device of claim 8, further comprising:
a second variable aperture control unit; and
a second variable aperture diaphragm, coupled to and controlled by the second variable aperture control unit, arranged in the projection optical system to control a shape of reflected light.

12. An exposure method comprising:
illuminating a mask with exposure light; and
forming, on a photosensitive substrate, an image of a pattern formed in the mask based on the exposure light having illuminated the mask using a projection optical system comprising an optical element having a rotationally symmetric aspheric surface represented by a non-even function Z=g(h), a distance between the aspheric surface and a plane perpendicular to the rotation axis of the aspheric surface being represented by Z wherein the distance is measured parallel to the rotation axis, and a distance from the rotation axis is h, and wherein the optical element performs a projection exposure on a second surface of an image of a pattern formed on a first surface.

13. The exposure method of claim 12, wherein the non-even function Z=g(h) has a derivative that is zero on the rotation axis.

14. A projection optical system, comprising:
an optical element having an aspheric surface with a configuration represented by a non-even function Z=g(h), a distance between the aspheric surface and a plane perpendicular to the rotation axis of the aspheric surface being represented by Z wherein the distance is measured parallel to the rotation axis, and a distance from the rotation axis is h, and
wherein the optical element performs a projection exposure on a second surface of an image of a pattern formed on a first surface.

15. The projection optical system of claim 14, wherein the projection optical system comprises six optical elements that are mirrors.

16. The projection optical system of claim 14, wherein the non-even function Z=g(h) has a derivative that is zero on the rotation axis.

17. The projection optical system of claim 14, wherein the non-even function of the configuration of the aspheric surface of the optical element is represented by the following equation:
$$Z = \frac{{h}^{2} / r}{1 + sqrt \{ 1 - ( 1 + k ) {h}^{2} / {r}^{2} \}} + {\sum }_{n = 2}^{28} {Cnh}^{n} ,$$
wherein the distance measured parallel to the rotation axis, Z, is an optical axis direction sag amount from a plane, r is a radius of curvature at a surface vertex, h is a distance from the rotation axis, k is a predetermined cone coefficient wherein when k=0, a first term is an expression for a spherical surface and when k=−1, the first term is an expression of a paraboloid, and C2-C28 are predetermined 2nd through 28th aspheric coefficients.

18. The projection optical system of claim 14, wherein Z is a function having power series terms wherein odd number degree terms are added to even number degree terms and a degree of each term of the power series terms is greater than 1.

19. The projection optical system of claim 14, wherein the system is a reflection system.

20. The projection optical system of claim 14, wherein the projection optical system is a non-telecentric optical system.

21. The projection optical system of claim 14, further including:
a variable aperture control unit; and
a variable aperture diaphragm controlled by the variable aperture control unit, arranged to control a shape of reflected light.

22. A projection optical system, comprising:
an optical element having an aspheric surface with an aspheric surface configuration represented by a function having maximized degrees of freedom for the aspheric surface configuration of a whole surface of the at least one optical element,
wherein the optical element performs a projection exposure on a second surface of an image of a pattern formed on a first surface.

23. The projection optical system of claim 22, wherein the function of the aspheric surface configuration of the optical element is represented by the following equation:
$$Z = \frac{{h}^{2} / r}{1 + sqrt \{ 1 - ( 1 + k ) {h}^{2} / {r}^{2} \}} + {\sum }_{n = 2}^{28} {Cnh}^{n} ,$$
wherein a distance between the aspheric surface and a plane perpendicular to the rotation axis of the aspheric surface is represented by Z where the distance is measured parallel to the rotation axis, r is a radius of curvature at a surface vertex, h is a distance from the rotation axis, k is a predetermined cone coefficient wherein when k=0, a first term is an expression for a spherical surface and when k=−1, the first term is an expression of a paraboloid, and C2-C28 are predetermined 2nd through 28th aspheric coefficients.

24. The projection optical system of claim 22, wherein the system is a reflection system.

25. The exposure method of claim 12, wherein the image of the pattern is formed by stepwise scanning and illuminating the mask in a predetermined direction to obtain a plurality of shot regions that provide a whole pattern of the mask.

26. The exposure device of claim 8, further including:
a second variable aperture control unit; and
a second variable aperture diaphragm, coupled to the second variable aperture control unit and the projection optical system, and arranged to control a shape of light entering the projection optical system.

27. A method to manufacture microdevices using a projection optical system having at least one optical element having a rotationally symmetric aspheric surface and liquid crystal display cells, comprising:
illuminating a mask with exposure light;
forming, on a photosensitive substrate, an image of a pattern formed in the mask based on the exposure light having illuminated the mask using a projection optical system comprising an optical element having a rotationally symmetric aspheric surface represented by a non-even function Z=g(h) having a derivative that is zero on a rotation axis, wherein a distance measured parallel to a rotation axis is represented by Z and a distance from the rotation axis is h, and wherein the optical element performs a projection exposure on a second surface of an image of a pattern formed on a first surface;
forming color filters in accordance with the image; and
assembling liquid crystal display cells using the photosensitive substrate and the color filters.

28. A projection optical system, comprising:
optical means for reflecting light to form an image of an object in a wafer, the optical means having an aspheric surface with a configuration represented by a non-even function Z=g(h), a distance between the aspheric surface and a plane perpendicular to the rotation axis of the aspheric surface being represented by Z where the distance is measured parallel to the rotation axis, and a distance from the rotation axis is h.
